(19) United States
(12) Patent Application Publication
(10) Pub. No.: US 2007/0179216 A1
(43) Pub. Date: Aug. 2, 2007

(54) Method for producing aqueous polyurethane dispersions by means of flash evaporation

(75) Inventors: Matthias Orschel, Munster (DE); Wolfgang Sasse, Haltern am See (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: DEGUSSA AG, Duesseldorf (DE)

(21) Appl. No.: 11/629,290

(22) PCT Filed: May 2, 2005
(86) PCT No.: PCT/EP05/51987

§ 371 Date: Dec. 13, 2006

(51) Int. Cl. C08J 3/00

(52) U.S. Cl. 523/340

(57) ABSTRACT

The invention relates to a novel process for preparing aqueous polyurethane dispersions from solvent-containing, aqueous polyurethane dispersions or solutions by means of flash evaporation of the organic solvents or organic solvent mixtures, and also to a process for preparing aqueous polyurethane dispersions by converting hydrophilically modified NCO prepolymers or polyurethanes in an optionally aqueous, organic solvent or solvent mixture to an aqueous dispersion or aqueous solution and subsequently removing the organic solvent or solvent mixture.

The invention relates to a novel process for preparing solvent-free or low-solvent aqueous polyurethane dispersions from solvent-containing, aqueous polyurethane dispersions or solutions by means of flash evaporation of the organic solvents or organic solvent mixtures, and also to a process for preparing aqueous polyurethane dispersions by converting hydrophilically modified NCO prepolymers or polyurethanes in an optionally aqueous, organic solvent or solvent mixture to an aqueous dispersion or aqueous solution and subsequently removing the organic solvent or solvent mixture by means of flash evaporation.

Aqueous polyurethane dispersions are used, for example, for single-component, isocyanate-free varnishes, coatings, sealing compositions, adhesives and membranes. Their importance has been increasing ever more for many years for ecological (environmental compatibility, occupational safety) and economic reasons. The viscosity and the flow behavior are independent of the molar mass which can be adjusted over a wide range. In addition to these advantages, the possible applications of these low-solvent or solvent-free products already correspond substantially to those of the products containing solvent.

Processes for preparing aqueous polyurethane dispersions, here including both aqueous dispersions or suspensions of pure polyurethanes and of polyurethaneureas, are known and are described, for example, in the following references: Houben-Weyl, Methoden der organischen Chemie, Volume E 20, Part I; Ullmann's Encyclopedia of Industrial Chemistry, Release 2003, 7th Edition, Wiley-VCH Verlag; Adv. Urethane Sci. Technol. 10 (1987), 121-187; DE 198 12 751; DE 199 57 604; WO 96/40811; US 2002/0028877.

Of the processes mentioned, it is the “acetone process” in analogy to the teaching of DE 14 95 745 or to that of DE 14 95 847 that is of particular importance for the present invention. In this process, an NCO prepolymer is generally prepared initially and is dissolved in an inert solvent (optionally, the NCO prepolymer is also prepared directly in the inert solvent), which is followed by chain extension in solution to give the higher molecular weight polyurethane. The hydrophilic groups required for the dispersion are preferably incorporated either by incorporation of diols bearing ionic, potentially ionic or nonionic hydrophilic groups into the prepolymer or by using appropriate amines as chain extenders. The dispersion is effected batchwise in stirred tanks having a stirrer and possibly baffles. The solvent used is generally distilled out of the stirred tank immediately after the dispersion. Despite the outstanding properties of the products obtained by this procedure, the “acetone process” has considerable disadvantages. The long distillation times to remove the solvent reduce the space-time yield, increase the preparation costs and have a disadvantageous effect on the state of the dispersed particles, especially on their degree of swelling. The long thermal stress on the dispersion during distillation of the solvent may additionally lead to problems in the case of thermally sensitive dispersions.

Processes for preparing aqueous polyurethane dispersions by continuous dispersion are also known. DE 22 60 870 describes, for example, the use of special mixing reactors which are based on the cellular flows which form. The removal of the solvent used is achieved here with the aid of a thin-film evaporator. Although such an evaporator brings extremely short residence times and good heat transfer values, it leads in the case of film-forming dispersions to caking on the evaporator surface. In order to circumvent this disadvantage, DE 3603996 describes a process for continuously preparing aqueous polyurethane dispersions in barbed mixers in which the distillative removal of the majority of the solvent is effected continuously by means of a circulation evaporator. Owing to the evaporator surfaces which are always flooded, no film formation is observed even in the case of products which tend to film formation. However, the thus obtained dispersions still have an acetone content of approx. 10% which has to be removed by a subsequent distillation in a conventional distillation vessel.

It is therefore an object of the invention to develop a novel process for removing solvents from solvent-containing, aqueous polyurethane dispersions/solutions and a process for preparing aqueous polyurethane dispersions by the “acetone process” which is not burdened by the aforementioned disadvantages. This object is achieved by the provision of the process according to the invention described in detail hereinbelow.

The invention provides a process for preparing solvent-free or low-solvent aqueous polyurethane dispersions, which comprises removing the organic solvents or the organic solvent mixtures from solvent-containing, aqueous polyurethane dispersions or solutions by means of flash evaporation. In a preferred embodiment of the process, the invention further provides a process for removing organic solvents or organic solvent mixtures from solvent-containing, aqueous polyurethane dispersions or polyurethane solutions by means of flash evaporation, and also a process for preparing aqueous polyurethane dispersions by converting hydrophilically modified NCO prepolymers or polyurethanes in an optionally aqueous, organic solvent or solvent mixture to an aqueous dispersion or solution and subsequently removing the organic solvent or solvent mixture by means of flash evaporation.

In the inventive solvent removal, the vapors are generated by passing the preheated, solvent-containing, aqueous polyurethane dispersions or solutions into decompression vessels in which there is a lower pressure. At the same time, the evaporation of the solvent from the dispersion or solution results in the temperature in the remaining liquid phase falling, so that the thermal stress is reduced. It is not essential to the invention whether the removal of the solvent/solvent mixture is effected in one step or in several stages. The type of flash evaporation depends on the composition and the properties of the particular solvent-containing, aqueous polyurethane dispersion or solution and of the residual content of the solvent/solvent mixture to be attained. For instance, in the case of thermally sensitive dispersions, it may be advantageous to carry out the solvent removal in several stages at low temperatures, while robust dispersions are freed of solvent/solvent mixture in fewer stages at higher temperatures. It is not essential to the invention whether the removal of the solvent/solvent mixture is effected batchwise in several steps in a single-stage flash apparatus, or batchwise or continuously in a flash apparatus composed of several stages. It is possible in each step/in each stage to further reduce the pressure and/or the temperature and utilize the energy released, which is obtained by condensation of the vapors, for heating. A third variant is the removal of the solvent/solvent mixture in a single-stage flash evaporation apparatus in which the polyurethane dispersion or solution is passed from the flash vessel continuously through a liquid heater and brought to a higher temperature and a higher pressure and subsequently passed back into the flash vessel in which the pressure is lower. This continuously reduces the solvent concentration in the aqueous polyurethane dispersion. When the solvent-containing, aqueous polyurethane dispersion/solution is prepared beforehand batchwise in a stirred tank, preference is given to using this stirred tank as the flash vessel. In none of the variants is it essential to the invention how the solvent-containing, aqueous polyurethane dispersion or solution is introduced into the flash vessel. This can be effected, for example, by nozzle-spraying into the flash chamber or other prior art methods.

The specific embodiments of the process according to the invention described are intended only to illustrate the breadth of applicability, but the process according to the invention is not restricted thereto.

The boiling points of the organic solvents or solvent mixtures, or their azeotropes with water, are below the boiling point of water at the appropriate pressure at which the flash evaporation is carried out. In the solvent removal, a portion of the water is in some cases also removed, but this is not essential to the invention.

The advantages of the process according to the invention can be seen in that, compared to the prior art “acetone process”, the removal of the solvent proceeds distinctly more rapidly and product more gently, which achieves products in the process according to the invention which, with regard to the properties, are equivalent or superior to the products of the conventional “acetone process”. Moreover, a distinctly better space-time yield is achieved. In addition, the use of the flash evaporation in the case of products tending to film formation does not lead to film formation on the evaporator surfaces. The residual contents of the solvent in the polyurethane dispersion which are achieved by the application of the process according to the invention make a further distillative workup superfluous. The process according to the invention may be carried out continuously and batchwise.

In a particularly preferred embodiment of the invention, the polyurethane dispersions described in detail hereinbelow are prepared by the process according to the invention. The preparation of aqueous polyurethane dispersions by the “acetone process” comprises the steps of: preparing a hydrophilically modifiable or modified prepolymer (optionally in an inert, organic solvent/solvent mixture); optionally dissolving in an inert, organic solvent/solvent mixture; optionally neutralizing an anionically or cationically modifiable prepolymer/polyurethane to give an anionically or cationically modified prepolymer/polyurethane; extending the chain; dispersion; removing the solvent/solvent mixture.

Anionically or cationically modifiable (i.e. unneutralized) or nonionically modified polyurethane prepolymers suitable for the process according to the invention are known from the literature and are prepared by polyaddition reactions of polyols and polyisocyanate components and optionally solvents/solvent mixtures and/or catalysts. Polymeric and/or monomeric polyols having two or more hydroxyl groups reactive toward polyisocyanates are used, for example polyester polyols, polyether polyols, polyhydroxypolycarbonates, polyhydroxypolyacetals, polyhydroxypolyacrylates, polyhydroxypolyesteramides, polyhydroxypolythioethers, polyalkylenepolyols, polyhydroxypolycaprolactones, vinyl-modified polyether polyols, macromonomeric polyols, techelene or polyhydroxy epoxy resins or mixtures thereof, and/or any low molecular weight polyols, for example 1,2-ethanediol, 1,2-propanediol, 1,2-propylene glycol, 1,3-propanediol, 1,3-propylene glycol, 1,4-butanediol, 1,4-butylene glycol, 1,6-hexanediol, 2-methyl-1,3-propanediol, 2,2-dimethylol-1,3-propanediol, 1,4-bis(hydroxymethyl)cyclohexane, 1,2,3-propanetriol, 2-hydroxymethyl-2-methyl-1,3-propanol, 2-ethyl-2-hydroxymethyl-1,3-propanediol, 2,2-bis(hydroxymethyl)-1,3-propanediol or mixtures thereof. Examples of preferred polyisocyanate components are polyisocyanates, polyisocyanate derivatives or polyisocyanate homologues having two or more aliphatic, cycloaliphatic or aromatic isocyanate groups. Especially suitable are the polyisocyanates well known in polyurethane chemistry or combinations thereof, for example 1, 4-diisocyanatobutane, 1,6-diisocyanatohexane (HDI), 1,12-diisocyanatododecane, 1,4-diisocyanatocyclohexane, 1-isocyanato-5-isocyanatomethyl-3,3,5-trimethylcyclohexane (IPDI), bis(4-isocyanatocyclohexyl)methane (H₁₂MDI), 1,3-bis(1-isocyanato-1-methyl)benzene (XDI), 1,3-bis(1-isocyanato-1-methylethyl)benzene (m-TMXDI), 2,4-diisocyanatotoluene (TDI), bis(4-isocyanatophenyl)methane (MDI), 1,6-diisocyanato-2,2,4-(2,4,4)-trimethylhexane (TMDI) and any isomers, higher homologs or technical-grade mixtures of the individual polyisocyanates. In addition, mixtures and derivatives of the above-mentioned diisocyanates can also be used which have allophanate, biuret, carbodiimide, isocyanurate, uretdione or urethane groups, and optionally also blocked polyisocyanates, as described, for example, in DE 196 26 886.

The compounds used which have an anionically, cationically and/or nonionically dispersing action are those which contain, for example, carboxylate, sulfonate, phosphonate, sulfonium, ammonium, phosphonium groups or groups which can be converted to the aforementioned groups by salt formation (known as anionically or cationically modifiable groups/compounds), and/or polyether groups (known as nonionically emulsifying groups), and which can be incorporated into the prepolymers by existing isocyanate-reactive groups, and having two or more groups reactive toward polyisocyanates, for example compounds having OH and/or NH₂ groups. Representatives of these compounds are, for example, 2-hydroxymethyl-3-hydroxypropanoic acid, 2-hydroxymethyl-2-methyl-3-hydroxypropanoic acid, 2-hydroxy-methyl-2-ethyl-3-hydroxypropanoic acid, 2-hydroxymethyl-2-propyl-3-hydroxypropanoic acid, citric acid, tartaric acid, alanine, taurine, 2-aminoethylaminoethanesulfonic acid, polyethylene glycols, polypropylene glycols, polybutylene glycols which have been started on alcohols, the block copolymers thereof and monomethyl ethers of these polyglycols, and also all polymeric polyols having corresponding modification.

Preferred solvents are solvents inert toward isocyanate groups which have a boiling point below that of water (at the appropriate pressure at which the flash evaporation is carried out). These are, for example, benzene, ethyl acetate, acetone, methyl ethyl ketone, diethyl ether, tetrahydrofuran, methyl acetate, acetonitrile, chloroform, methylene chloride, carbon tetrachloride, 1,2-dichloroethane, 1,1,2-trichloroethane, tetrachloroethylene or mixtures thereof. Preference is given to using water-miscible solvents/solvent mixtures, very preferably acetone. However, it is also possible in special cases to use those solvents/solvent mixtures which are not inert toward isocyanate groups and have a boiling point below that of water, for example alcohols such as methanol, ethanol, or isopropanol. The solvents may under some circumstances also contain water.

In addition to the solvents/solvent mixtures which are removed after the dispersion step, still further auxiliary solvents which have a boiling point above that of water may be added, for example diisopropyl ketone, xylene, dimethylformamide, dimethylacetamide, dimethyl sulfoxide, methyl glycol acetate, ethyl glycol acetate, butyl acetate or N-methylpyrrolidone. These solvents ultimately remain in the low-solvent dispersions.

The neutralization components used for anionically modifiable polyurethane prepolymers are bases, for example tertiary amines, e.g. N,N-dimethylethanolamine, N-methyldiethanolamine, triethanolamine, N,N-dimethylisopropanolamine, N-methyldiisopropanolamine, triisopropylamine, N-methylmorpholine, N-ethylmorpholine, triethylamine or ammonia, or alkali metal hydroxides, e.g. lithium hydroxide, sodium hydroxide or potassium hydroxide. For cationically modifiable polyurethane prepolymers, corresponding acids are used, for example formic acid, acetic acid, propionic acid, sulfuric acid, dimethyl sulfate or succinic acid. In the case of the nonionically modified polyurethane prepolymers, the neutralization step is dispensed with.

In the reaction step in which the molar mass increase takes place, the chain extender components used are polyamines having two or more amino groups reactive toward polyisocyanates. Suitable polyamines are, for example, adipic dihydrazide, ethylenediamine, diethylenetriamine, triethylenetetramine, tetraethylenepentamine, pentaethylenehexamine, dipropylenetriamine, hexamethylenediamine, hydrazine, isophoronediamine, N-(2-amino-ethyl)-2-aminoethanol, 1,3- and 1,4-phenylenediamine, 4,4′-diphenylmethanediamine, amino-functional polyethylene oxides or polypropylene oxides, adducts of salts of 2-acrylamido-2-methylpropane-1-sulfonic acid and ethylenediamine or any combinations of polyamines.

The individual process steps of the preparation of aqueous polyurethane dispersions by the “acetone process” are effected in any known manner, continuously or batchwise, according to the prior art. The dispersion or the mixing the majority of the water is effected with suitable mixer units. In the batchwise preparation, these are, for example, stirred tanks which are equipped with suitable stirrers and possibly baffles. For the continuous preparation, in addition to the abovementioned processes, for example, the stirrer aggregates or rotor-stator mixing elements described in GB 14 14 930, DE 22 60 870, DE 23 11 635, DE 23 47 299, DE 23 44 135, DE 33 19 921, DE 36 03 996, U.S. Pat. No. 4,742,095 or in M. Keyvani, Advances in Polymer Technology, 22 (2003), 218-224, but also static mixers may be used. However, these procedures are not essential to the invention.

What is essential to the invention is only the removal of the solvent/solvent mixture from solvent-containing, aqueous polyurethane dispersions or solutions by flash evaporation. Suitable apparatus and the principle of the process are described in, for example, Ullmann's Encyclopedia of Industrial Chemistry, Release 2003, 7th Edition, Wiley-VCH Verlag; Henglein, Lexikon der chemischen Technik [Dictionary of chemical technology], 1st Edition, VCH Verlagsgesellschaft, 1988; Vauck, Müller, Grundoperationen chemischer Verfahrenstechnik [Basic operations of chemical process technology], 11th Edition, Deutscher Verlag für Grundstoffindustrie, 2000.

In a preferred exemplary embodiment of the process according to the invention, a solvent-containing, aqueous polyurethane dispersion or solution is passed from a reservoir continuously through a liquid heater and a nozzle into what is known as a vapor chamber in which the pressure has been reduced to such an extent that a portion of the solvent evaporates. The vapors are removed from the vapor chamber and condensed in a heat exchanger. Subsequently, the concentrated dispersion is passed through a further liquid heater into a further vapor chamber. For example, the vapors of the first vapor chamber may be utilized as a heating medium. In the second vapor chamber, flash evaporation is likewise effected. The pressure in the second vapor chamber may be reduced further compared to the first vapor chamber. The number of flash evaporation stages depends upon the target concentration of the solvent to be achieved. At the end, an aqueous polyurethane dispersion is obtained which, depending on the objective, may still have a residual concentration of solvent.

The examples which follow serve to further illustrate the process according to the invention, without it being restricted thereto.

### EXAMPLE 1

Preparation of a Solvent-Containing, Aqueous Polyurethane Dispersion

A stirred tank was initially charged with 6792 g of a 50% solution of VESTANAT T1890 (manufacturer: Degussa AG) in acetone, 2068 g of isophorone diisocyanate, 20 g of dibutyltin laurate, 624 g of dimethylolpropionic acid and 3492 g of acetone, and the temperature was adjusted to 60° C. and the stirrer to 180 rpm. Subsequently, 1248 g of trimethylolpropane and 9583 g of Oxyester T1136 (manufacturer: Degussa AG) were added. On attainment of an NCO number of 0.5%, 226 g of methyl ethyl ketoxime and, 1 h later, 544 g of diethylaminoethanol and a solution of 7500 g of VESTANAT B 1358/100 (manufacturer: Degussa AG), 7500 g of acetone, 128 g of Tinuvine 900 (manufacturer: Ciba Geigy) and 128 g of Tinuvine 292 (manufacturer: Ciba Geigy) were added. The thus obtained, acetone-containing resin solution was subsequently dispersed in 59 800 g of water to give an acetone-containing, aqueous polyurethane dispersion (acetone content: 14.4%; solids content: 25.6%).

### COMPARATIVE EXAMPLE A

Conventional Removal of the Solvent by Means of Distillation

48 600 g of the acetone-containing, aqueous polyurethane dispersion from Example 1 were heated to 60° C. in a reactor having a capacity of approx. 50 l and an Inter-MIG stirrer and attached distillation column, and vacuum was applied. Owing to the vigorous foaming of the dispersion, the pressure was reduced slowly, from 600 to 60 mbar within 10.5 h. The resulting dispersion was corrected using water to a solids content of 33.7% and the characteristic data were determined (pH: 8.7; viscosity: 111 mPa*s; average particle size diameter: 115 nm; acetone content: 0.39%).

### EXAMPLE 2

Removal of the Solvent by Means of Flash Evaporation

48 000 g of the acetone-containing, aqueous polyurethane dispersion from Example 1 were heated in a reservoir to a temperature of 59° C. at a pressure of 1 bar and passed continuously through a pipeline (internal diameter=6 mm) into a flash vessel (throughput: 20.2 kg/h) in which there was a pressure of 137 mbar. The resulting vapors were withdrawn via a side draw and condensed in a condenser. The product withdrawn from the bottom had an acetone content of 3.8% and was used in the apparatus two further times. The conditions were comparable to the first throughput, only the pressure was reduced further (to 90 mbar and subsequently to 64 mbar) and the throughput increased (to 25.4 kg/h and subsequently to 30.1 kg/h). This further reduced the acetone content in stages (to 1.6% and subsequently to 0.4%). The entire process for solvent removal took 5.5 h. The resultant dispersion was corrected using water to a solids content of 33.3% and the characteristic data were determined (pH: 8.9; viscosity: 95 mPa*s; particle size diameter: 110 nm; acetone content: 0.41%).

1. A process for preparing solvent-free or low-solvent aqueous polyurethane dispersions from solvent-containing, aqueous polyurethane dispersions or solutions,
which comprises
removing the organic solvents or the organic solvent mixtures from the solvent-containing, aqueous polyurethane dispersions or solutions by means of flash evaporation.

2. A process for removing organic solvents or organic solvent mixtures from solvent-containing, aqueous polyurethane dispersions or polyurethane solutions by means of flash evaporation.

3. The process according to claim 1,
wherein
the solvent or solvent mixture removal is carried out continuously or batchwise in one or more flash evaporation stages.

4. The process according to claim 1,
wherein
the pressure and/or the temperature is/are reduced stepwise when a plurality of flash evaporation stages is used.

5. The process according to claim 1,
wherein
some water is also removed in the solvent or solvent mixture removal.

6. The process according to claim 1,
wherein
the solvent-containing, aqueous polyurethane dispersions or solutions are prepared using solvents inert or reactive toward isocyanate groups.

7. The process according to claim 1,
wherein
the solvents or solvent mixtures, at the pressure at which the flash evaporation is carried out, have a boiling point below that of water, or their azeotrope with water is below the boiling point of water.

8. The process according to claim 1,
wherein
water-miscible solvents/solvent mixtures are used.

9. The process according to claim 1,
wherein
aqueous solvents are used.

10. The process according to claim 1,
wherein
the solvent/solvent mixture is removed in a single-stage flash evaporation apparatus in which the polyurethane dispersion or solution is passed from the flash vessel continuously through a liquid heater and brought to a higher temperature and a higher pressure and subsequently passed back into the flash vessel in which the pressure is lower.

11. The process according to claim 1,
wherein
the solvent-containing, aqueous polyurethane dispersion/solution is prepared beforehand batchwise in a stirred tank, and this stirred tank is used as the flash vessel.

12. The process according to claim 1,
wherein
the solvent-containing, aqueous polyurethane dispersions or solutions are prepared by adding still further auxiliary solvents which remain in the finished low-solvent dispersion.

13. A process for preparing aqueous polyurethane dispersions by converting hydrophilically modified NCO prepolymers and polyurethanes in an optionally aqueous, organic solvent or solvent mixture to a solvent-containing, aqueous dispersion or solution and subsequently removing the organic solvent or solvent mixture by means of flash evaporation.

14. The process according to claim 13,
wherein
the solvent-containing, aqueous polyurethane dispersion or solution is prepared continuously or batchwise.

15. The process according to claim 13,
wherein
the preparation of the aqueous polyurethane dispersions comprises the following steps: a) preparing a hydrophilically modifiable or modified polyurethane prepolymers, optionally in an organic solvent/solvent mixture; b) optionally dissolving in an organic solvent/solvent mixture; c) optionally neutralizing an anionically or cationically modifiable prepolymer/polyurethane to give an anionically or cationically modified prepolymer/polyurethane; d) optionally extending the chain; e) dispersing; and f) removing the solvent/solvent mixture by means of flash evaporation.

16. The process according to claim 1,
wherein
the starting compounds used for the preparation of the polyurethane prepolymers are polyisocyanates selected from the group consisting of 1,4-diisocyanatobutane, 1,6-diisocyanatohexane (HDI), 1,12-diisocyanatododecane, 1,4 diisocyanatocyclohexane, 1-isocyanato-5-isocyanatomethyl-3,3,5-trimethylcyclohexane (IPDI), bis(4-isocyanatocyclohexyl)methane (H12MDI), 1,3-bis(1-isocyanato-1-methyl)benzene (XDI), 1,3-bis(1-isocyanato-1-methylethyl)benzene (m-TMXDI), 2,4-diisocyanatotoluene (TDI), bis(4-isocyanatophenyl)methane (MDI), and 1,6-diisocyanato-2,2,4(2,4,4)-trimethylhexane (TMDI).
